(19) United States
(12) Patent Application Publication
(10) Pub. No.: US 2025/0026231 A1
(43) Pub. Date: Jan. 23, 2025

(54) INFORMATION PROVISION DEVICE, INFORMATION PROVISION METHOD, AND STORAGE MEDIUM

(71) Applicant: HONDA MOTOR CO., LTD., Tokyo (JP)

(72) Inventor: Jin Katsuya, Wako-shi (JP)

(21) Appl. No.: 18/757,592

(22) Filed: Jun. 28, 2024

(30) Foreign Application Priority Data
Jul. 18, 2023 (JP) 2023-116717

(51) Int. Cl. B60L 53/66; B60L 53/12; H02J 50/00; H02M 7/537

(52) U.S. Cl. CPC B60L 53/66; B60L 53/12; H02J 50/00; H02M 7/537

(57) ABSTRACT

An information provision device acquires power receiving information and positional information on the power reception through communication from a communication device installed in a vehicle equipped with a power receiving device that receives power from a power supply device installed on a road in a contactless manner, calculates an area power consumption by aggregating the power receiving information for each area on the basis of the positional information, and visualizes the area power consumption to provide it to other devices.

### CROSS-REFERENCE TO RELATED APPLICATION

Priority is claimed on Japanese Patent Application No. 2023-116717, filed Jul. 18, 2023, the content of which is incorporated herein by reference.

### BACKGROUND

### Field of the Invention

The present invention relates to an information provision device, an information provision method, and a storage medium.

### Description of Related Art

To realize a decarbonized society, the electrification of automobiles is being promoted, and methods are being used to increase the capacity of an in-vehicle battery to ensure a long cruising range of electric vehicles (Japanese Unexamined Patent Application, First Publication No. 2022-176733).

In the conventional technology described above, a temporary power supply load has increased due to rapid charging of an in-vehicle battery. As the power supply load increases due to the rapid charging of the in-vehicle battery, it becomes difficult to ensure power due to power shortages.

The present invention has been made in view of such circumstances, and an object thereof is to provide an information provision device, an information provision method, and a storage medium that can provide data that allows the amount of power required to charge an in-vehicle battery in each district to be ascertained accurately.

### SUMMARY OF THE INVENTION

The information provision device, the information provision method, and the storage medium according to the present invention have the following configurations.

(1): An information provision device according to one aspect of the present invention includes a storage medium configured to store computer-readable instructions, and one or more processors that are connected to the storage medium, in which the one or more processors execute the computer-readable instructions to acquire power receiving information and positional information on the power reception through communication from a communication device installed in a vehicle equipped with a power receiving device that receives power from a power supply device installed on a road in a contactless manner, calculate an area power consumption by aggregating the power receiving information for each area on the basis of the positional information, and visualize the area power consumption to provide it to other devices.

(2): In the aspect of (1) described above, the one or more processors may execute the computer-readable instructions to switch a size of the area between an urban area and other areas.

(3): In the aspect of (2) described above, the one or more processors may execute the computer-readable instructions to make a size of an area of the urban area larger than a size of an area of other areas.

(4): In the aspect of (1) described above, the one or more processors may execute the computer-readable instructions to acquire, in addition to power receiving information on the power reception, information on power consumption of an in-vehicle device installed in the vehicle, and visualizing the power consumption of the in-vehicle device to provide it to other devices.

(5): An information provision method that is executed by an information provision device according to another aspect of the present invention, includes acquiring power receiving information and positional information on the power reception through communication from a communication device installed in a vehicle equipped with a power receiving device that receives power from a power supply device installed on a road in a contactless manner, calculating an area power consumption by aggregating the power receiving information for each area on the basis of the positional information, and visualizing the area power consumption to provide it to other devices.

(6): A non-transitory computer readable storage medium according to still another aspect of the present invention stores a program for causing a processor of an information provision device to execute processing of acquiring power receiving information and positional information on the power reception through communication from a communication device installed in a vehicle equipped with a power receiving device that receives power from a power supply device installed on a road in a contactless manner, processing of calculating an area power consumption by aggregating the power receiving information for each area on the basis of the positional information, and processing of visualizing the area power consumption to provide it to other devices.

According to the aspects of (1) to (6), it is possible to provide data that allows the amount of power required to charge an in-vehicle battery in each area to be ascertained accurately by acquiring vehicle power consumption data and visualizing it as area power consumption.

### BRIEF DESCRIPTION OF THE DRAWINGS

FIG. 1 is a diagram which shows a configuration of a contactless power transmission system.

FIG. 2 is a diagram which shows a configuration of a power transmitting unit and a power receiving unit of the contactless power transmission system.

FIG. 3 is a block diagram which shows a functional configuration of a control device in the contactless power transmission system.

FIG. 4 is a block diagram which shows a functional configuration related to power supply control of the control device in the contactless power transmission system.

FIG. 5 is a block diagram which shows a functional configuration of the control device related to power storage device protection in the contactless power transmission system.

FIG. 6 is a block diagram which shows a functional configuration of a power estimation unit and a discharge limit protection unit of the control device in the contactless power transmission system.

FIG. 7 is a block diagram which shows a functional configuration of a power estimation unit and a charge limit protection unit of the control device in the contactless power transmission system.

FIG. 8 is a diagram which shows an example of a configuration of a vehicle and an information provision device.

FIG. 9 is an example of a result of meshing processing performed by the calculation unit.

FIG. 10 is a flowchart which shows an example of an operation of the first embodiment.

FIG. 11 is a diagram which shows an example of average on-road stopping time.

### DETAILED DESCRIPTION OF THE INVENTION

### First Embodiment

A first embodiment of an information provision device, an information provision method, and a storage medium of the present invention will be described below with reference to the drawings. An information provision device is realized by one or more processors. An information provision device is a device that collects information obtained through a contactless power transmission system configured to allow vehicles to receive power in a contactless manner from a power supply device installed on a road, and provides information on the basis of the collected information. An information provision device may be realized by a service operator installing a program on a cloud server, and in that case, an owner of hardware of the information provision device and an operator of a bike rental service may be different.

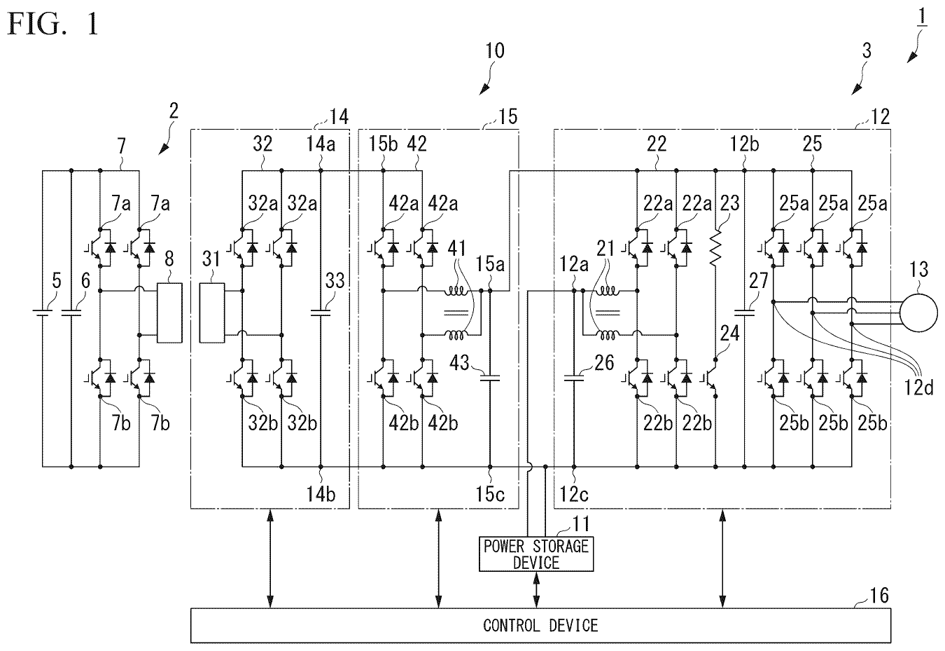

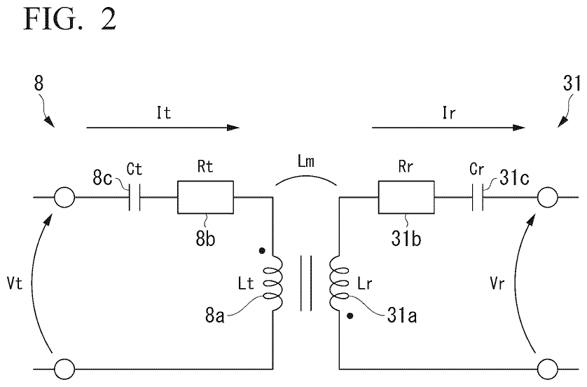

First, a configuration of a contactless power transmission system 1 used in each embodiment will be described. FIG. 1 is a diagram which shows the configuration of the contactless power transmission system 1. FIG. 2 is a diagram which shows a configuration of a power transmitting unit 8 and a power receiving unit 31 of the contactless power transmission system 1. The power control device 10 is mounted in a vehicle such as an electrically driven vehicle. Electrically driven vehicles include electric vehicles, hybrid vehicles, fuel cell vehicles, and the like. The contactless power transmission system 1 including a power control device 10 supplies electric power to a vehicle from outside the vehicle through power transmission in a contactless manner (same below).

The contactless power transmission system 1 includes, for example, a power transmission device 2 installed on a travel path of a vehicle M, and a driving control device 3 and a power control device 10 installed in a vehicle M such as a hybrid vehicle M. The power transmission device 2 includes, for example, a power supply unit 5, a capacitor 6, a power conversion unit 7, and a power transmitting unit 8. Note that the power transmission device 2 may include at least a plurality of power transmitting units 8 at a predetermined power transmission section on the travel path of the vehicle M, for example. The power supply unit 5 includes, for example, an AC power source such as a commercial power source, and an AC-DC converter that converts AC power into DC power. The power supply unit 5 converts AC power supplied from an AC power source into DC power using an AC-DC converter. The capacitor 6 is connected in parallel to the power supply unit 5. The capacitor 6 smoothes the DC power output from the power supply unit 5.

The power conversion unit 7 includes, for example, an inverter that converts DC power to AC power. The inverter of the power conversion unit 7 includes a bridge circuit formed by a plurality of switching elements and rectifying elements that are bridge-connected in two phases. Each switching element is, for example, a transistor such as a metal oxide semi-conductor field effect transistor (MOSFET) of silicon carbide (SiC). The plurality of switching elements are high-side arm and low-side arm transistors 7a and 7b that form a pair in each phase. A collector of the high-side arm transistor 7a is connected to a positive electrode of the power supply unit 5. An emitter of the low-side arm transistor 7b is connected to a negative electrode of the power supply unit 5. The emitter of the high-side arm transistor 7a and the collector of the low-side arm transistor 7b are connected to a power transmitting unit 8. The rectifying element is, for example, a reflux diode connected in parallel in a forward direction from the emitter to the collector between the collector and emitter of each of the transistors 7a and 7b.

The power transmitting unit 8 transmits power due to a change in a high-frequency magnetic field, for example, by magnetic field coupling such as magnetic field resonance or electromagnetic induction. As shown in FIG. 2, the power transmitting unit 8 includes, for example, a resonant circuit formed by a primary side coil 8a, a primary side resistor 8b, and a primary side capacitor 8c connected in series. The power transmitting unit 8 includes, for example, a sensor such as a current sensor that detects a current It flowing through the resonant circuit.

As shown in FIG. 1, the driving control device 3 of the vehicle M includes, for example, a power storage device 11, a first power conversion device 12, and a rotating electric machine 13. The power control device 10 of the vehicle M includes, for example, a power receiving device 14, a second power conversion device 15, and a control device 16. The power storage device 11 is charged by power transmitted contactlessly from a power transmission device 2 outside the vehicle M. The power storage device 11 transfers and receives power to and from the rotating electric machine 13 via the first power conversion device 12. The power storage device 11 includes, for example, a battery such as a lithium-ion battery, a current sensor that detects a current of the battery, and a voltage sensor that detects a voltage of the battery. The power storage device 11 is connected to a positive terminal 12a and a negative terminal 12c on a primary side of a first power conversion device 12, which will be described below.

The first power conversion device 12 includes, for example, a voltage controller that converts input power and output power during charging and discharging of the power storage device 11 by bidirectional step-up and step-down voltage conversion, and a power converter that performs conversion of DC power and AC power. The first power conversion device 12 includes, for example, a pair of reactors 21, a first element module 22, a resistor 23, a switching element 24, a second element module 25, a first capacitor 26, and a second capacitor 27. For example, the pair of reactors 21, the first element module 22, and the first capacitor 26 constitute a voltage controller, and the second element module 25 and the second capacitor 27 constitute a power converter.

The pair of reactors 21 form a composite reactor by opposite polarities thereof being magnetically coupled to each other. The pair of reactors 21 are connected to the positive terminal 12a on the primary side and the first element module 22. The first element module 22 includes, for example, a bridge circuit formed by a plurality of switching elements and rectifying elements that are bridge-connected in two phases. Each switching element is, for example, a transistor such as a MOSFET of SiC. The plurality of switching elements are high-side arm and low-side arm transistors 22a and 22b that form a pair in each phase. A collector of the high-side arm transistor 22a is connected to the positive terminal 12b on a secondary side. An emitter of the low-side arm transistor 22b is connected to a common negative terminal 12c on the primary side and the secondary side. The emitter of the high-side arm transistor 22a and the collector of the low-side arm transistor 22b are connected to the reactor 21. The rectifying element is, for example, a reflux diode connected in parallel in the forward direction from the emitter to the collector between the collector and emitter of each of the transistors 22a and 22b.

The first element module 22 includes, for example, a voltage sensor that detects a voltage between the positive terminal 12a and the negative terminal 12c on the primary side, and a current sensor that detects a current flowing through the pair of reactors 21.

The pair of reactors 21 and the first element module 22 perform voltage conversion by so-called two-phase interleave. In the two-phase interleave, among the two-phase transistors 22a and 22b connected to the pair of reactors 21, one period of switching control of first phase transistors 22a and 22b, and one period of switching control of second phase transistors 22a and 22b are shifted from each other by a half period.

The resistor 23 and the switching element 24 are connected in series. The switching element 24 is, for example, a transistor such as a MOSFET of SiC. The resistor 23 is connected to a positive terminal 12b on the secondary side and a collector of the switching element 24, and an emitter of the switching element 24 is connected to the negative terminal 12c. The second element module 25 includes, for example, a bridge circuit formed by a plurality of switching elements and rectifying elements that are bridge-connected in three phases. Each switching element is, for example, a transistor such as a MOSFET of SiC. The plurality of switching elements are high-side arm and low-side arm transistors 25a and 25b that form a pair in each phase. A collector of the high-side arm transistor 25a is connected to the positive terminal 12b on the secondary side. An emitter of the low-side arm transistor 25b is connected to the negative terminal 12c. An emitter of the high-side arm transistor 25a and a collector of the low-side arm transistor 25b are connected to a stator winding of the rotating electric machine 13 via an AC terminal 12d. The rectifying element is, for example, a reflux diode connected in parallel in the forward direction from the emitter to the collector between the collector and emitter of each of the transistors 25a and 25b. The second element module 25 includes, for example, a current sensor that detects a current flowing from each AC terminal 12d to a stator winding of the rotating electric machine 13.

The first capacitor 26 is connected to the positive terminal 12a and the negative terminal 12c on the primary side. The second capacitor 27 is connected to the positive terminal 12b and negative terminal 12c on the secondary side between the first element module 22 and the second element module 25. Each capacitor 26 smoothes voltage fluctuations that occur when a switching operation is performed on each switching element to turn it on (allow conduction) and off (blocking).

The second element module 25 controls an operation of the rotating electric machine 13 by transmitting and receiving power. For example, when the rotating electric machine 13 is powered, the second element module 25 converts the DC power input from the positive terminal and the negative terminal into three-phase AC power, and supplies the three-phase AC power to the rotating electric machine 13. The second element module 25 generates a rotational driving force by sequentially commutating a current to three-phase stator windings of the rotating electric machine 13. For example, during regeneration of the rotating electric machine 13, the second element module 25 converts three-phase AC power input from the three-phase stator windings into DC power by turning on (allowing conduction) and off (blocking) the switching elements of each phase synchronized with a rotation of the rotating electric machine 13. The second element module 25 can supply DC power converted from three-phase AC power to the power storage device 11 via the pair of reactors 21 and the first element module 22.

The rotating electric machine 13 is, for example, a three-phase AC brushless DC motor. The rotating electric machine 13 includes a rotor that has a permanent magnet for a field, and a stator that has three-phase stator windings that generate a rotating magnetic field for rotating the rotor. The three-phase stator windings are connected to the three-phase AC terminals 12d of the first power conversion device 12. The rotating electric machine 13 generates a rotational driving force by performing a power operation using power supplied from the first power conversion device 12. For example, when the rotating electric machine 13 can be connected to wheels of the vehicle M, the rotating electric machine 13 generates a traveling driving force by performing a power operation using the power supplied from the first power conversion device 12. The rotating electric machine 13 may generate power by performing a regenerative operation using rotational power input from the wheels of the vehicle M. When the rotating electric machine 13 can be connected to an internal combustion engine of the vehicle M, it may generate electricity using power of the internal combustion engine.

The power receiving device 14 includes, for example, the power receiving unit 31, the power conversion unit 32, and a capacitor 33. As shown in FIG. 2, the power receiving unit 31 receives power according to a change in a high frequency magnetic field transmitted from the power transmitting unit 8 according to magnetic field coupling, such as magnetic field resonance or electromagnetic induction. The power receiving unit 31 includes, for example, a resonant circuit formed by a secondary coil 31a, a secondary resistor 31b, and a secondary capacitor 31c connected in series. The power receiving unit 31 includes, for example, a sensor such as a current sensor that detects a current Ir flowing through the resonant circuit.

As shown in FIG. 1, the power conversion unit 32 includes a so-called full bridgeless type (or bridgeless and totem pole type) power factor correction (PFC) circuit that converts AC power into DC power. A so-called bridgeless PFC is a PFC that does not have a bridge rectifier using a plurality of diodes connected in a bridge, and a so-called totem pole PFC is a PFC that includes a pair of switching elements of the same conductivity type that are connected in series in the same direction (totem pole connection).

The power conversion unit 32 includes, for example, a bridge circuit formed by a plurality of switching elements and rectifying elements that are bridge-connected in two phases. Each switching element is, for example, a transistor such as a MOSFET of SiC. The plurality of switching elements are high-side arm and low-side arm transistors 32a and 32b that form a pair in each phase. A collector of the high-side arm transistor 32a is connected to a positive terminal 14a on the secondary side. An emitter of the low-side arm transistor 32b is connected to a negative terminal 14b on the secondary side. An emitter of the high-side arm transistor 32a and a collector of the low-side arm transistor 32b are connected to the power receiving unit 31. The rectifying element is, for example, a reflux diode connected in parallel in the forward direction from the emitter to the collector between the collector and emitter of each of the transistors 32a and 32b. The capacitor 33 is connected to the positive terminal 14a and the negative terminal 14b on the secondary side. The capacitor 33 smoothes voltage fluctuations that occur when each switching element is turned on (allow conduction) and off (blocking).

The second power conversion device 15 outputs arbitrary DC power by converting the DC power output from the power receiving device 14. The second power conversion device 15 includes, for example, a voltage converter that performs step-down voltage conversion. The second power conversion device 15 includes, for example, a pair of reactors 41, an element module 42, and a capacitor 43.

The pair of reactors 41 form a composite reactor by opposite polarities thereof being magnetically coupled to each other. The pair of reactors 41 are connected to a positive terminal 15a on the secondary side and the element module 42.

The element module 42 includes a bridge circuit formed by a plurality of switching elements and rectifying elements that are bridge-connected in two phases. Each switching element is, for example, a transistor such as a MOSFET of SiC. The plurality of switching elements are high-side arm and low-side arm transistors 42a and 42b that form a pair in each phase. A collector of the high-side arm transistor 42a is connected to a positive terminal 15b on the primary side. An emitter of the low-side arm transistor 42b is connected to a common negative terminal 15c on the primary side and the secondary side. An emitter of the high-side arm transistor 42a and a collector of the low-side arm transistor 42b are connected to the reactor 41. The rectifying element is, for example, a reflux diode connected in parallel in the forward direction from the emitter to the collector between the collector and emitter of each of the transistors 42a and 42b.

The pair of reactors 41 and the element module 42 perform voltage conversion by so-called two-phase interleave. In the two-phase interleave, among the two-phase transistors 42a and 42b connected to the pair of reactors 41, one period of switching control of first phase transistors 42a and 42b, and one period of switching control of second phase transistors 42a and 42b are shifted by a half period. The capacitor 43 is connected to the positive terminal 15a and the negative terminal 15c on the secondary side. The capacitor 43 smoothes voltage fluctuations that occur when each switching element is turned on (allow conduction) and off (blocking).

The positive terminal 15b on the primary side of the second power conversion device 15 is connected to the positive terminal 14a on the secondary side of the power receiving device 14. The positive terminal 15a on the secondary side of the second power conversion device 15 is connected to the positive terminal 12b on the secondary side of the first power conversion device 12. The negative terminal 15c of the second power conversion device 15 is connected to the negative terminal 14b on the secondary side of the power receiving device 14 and the negative terminal 12c of the first power conversion device 12.

The control device 16 integrally controls, for example, the driving control device 3 and the power control device 10 of the vehicle M. The control device 16 is a software functional unit that functions by executing a predetermined program using a processor such as a central processing unit (CPU). The software functional unit is an ECU that includes electronic circuits such as a processor such as a CPU, a read only memory (ROM) that stores a program, a random access memory (RAM) that temporarily stores data, and a timer. Note that at least a part of the control device 16 may be an integrated circuit such as a large scale integration (LSI).

For example, the control device 16 generates a control signal that indicates a timing to turn each switching element on (allow conduction) and off (blocking), and a gate signal for actually turning each switching element on (allowing conduction) and off (blocking) on the basis of the control signal. For example, the control device 16 rectifies the AC power received from the power transmission device 2 into DC power and improves a power factor of an input voltage and an input current by controlling switching of each switching element of the power receiving device 14. For example, the control device 16 controls an output according to a target output by a synchronous rectification operation of synchronously turning on (allowing conduction) and off (blocking) the plurality of switching elements of the power receiving device 14, and a short circuit operation of short-circuiting the secondary coil 31a.

For example, the control device 16 detects a current generated in the power receiving unit 31 by the power transmitted from the power transmitting unit 8, that is, the current Ir flowing through the secondary coil 31a, and controls a synchronous rectification operation according to a size and a phase of the current Ir. In a high output area such as the maximum output of the power receiving device 14, the control device 16 controls each switching element by soft switching of so-called zero voltage switching (ZVS). To reduce switching loss due to high frequency switching, the control device 16 performs soft switching by setting a dead time correction value according to a vehicle height condition related to a distance between the primary side coil 8a and the secondary coil 31a, electrical characteristics of the vehicle M, and the like. In zero voltage switching (ZVS), each switching element is turned on (switching from an off state to an on state) after the voltage across it is brought to zero by discharging an output capacitance (parasitic capacitance) in the off state during a dead time period of each phase.

For example, in a short-circuit operation, the control device 16 continues the synchronous rectification operation at zero voltage switching (ZVS) in the high-side arm of each phase, and turns on only the low-side arm of each phase to short-circuit the secondary coil 31a. When the low-side arm of each phase is turned on, a current accumulated in the secondary capacitor 31c connected in series with the secondary coil 31a flows out to the capacitor 33 for smoothing through the reflux diode of the high-side arm. As a result, a voltage Vr between both ends of the secondary coil 31a decreases to zero, and the secondary coil 31a ceases to function as a coil due to no potential difference, so that the current Ir due to a magnetic field generation with the power transmitting unit 8 is very small. At this time, when the power receiving device 14 on the secondary side is viewed from the power transmission device 2 on the primary side, an impedance on the secondary side becomes very large, and an impedance on the primary side also becomes large, so that a current on the primary side (a power transmission current: a current It flowing through the coil 8a on the primary side) is throttled. That is, the current in the power transmission device 2 on the primary side is controlled by the power receiving device 14 on the secondary side.

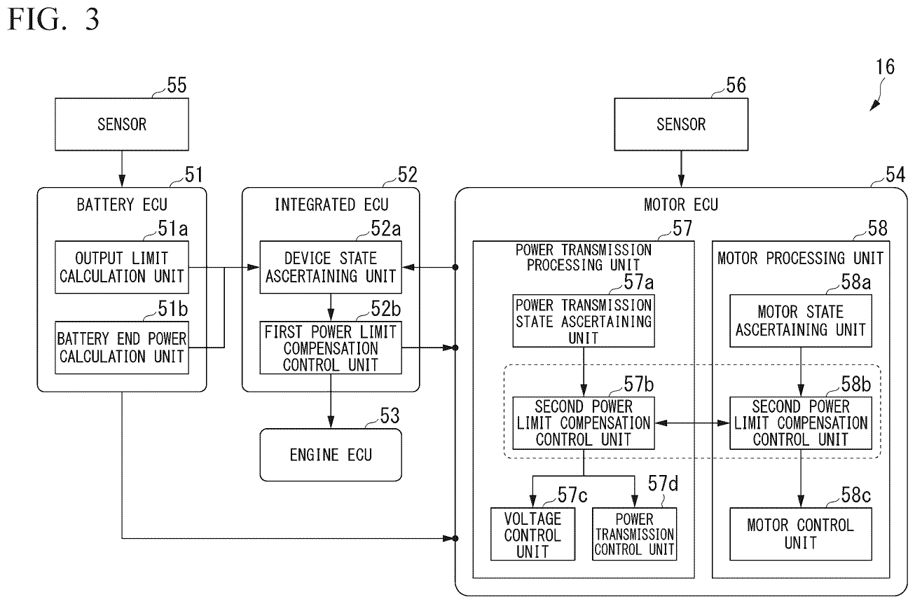

FIG. 3 is a block diagram which shows a functional configuration of the control device 16 in the contactless power transmission system 1. As shown in FIG. 3, the control device 16 includes, for example, a battery ECU 51, an integrated ECU 52, an engine ECU 53, a motor ECU 54, various sensors 55 connected to the battery ECU 51, and various sensors 56 connected to the motor ECU 54. The battery electronic control unit (ECU) 51 includes, for example, an output limit calculation unit 51a and a battery end power calculation unit 51b. The output limit calculation unit 51a calculates a target power limit value for each of charging and discharging of the power storage device 11. The battery end power calculation unit 51b calculates actual power at an input or output end of the power storage device 11 (battery end power) based on a signal of a detection value output from the various sensors 55. The target power limit value calculated by the output limit calculation unit 51a and the battery end power calculated by the battery end power calculation unit 51b are input to, for example, the integrated ECU 52 and the motor ECU 54.

The integrated ECU 52 includes, for example, a device state ascertaining unit 52a and a first power limit compensation control unit 52b. The device state ascertaining unit 52a ascertains states of various devices of the vehicle M based on the target power limit value and battery end power inputted from the battery ECU 51, an output of the power transmission inputted from a motor ECU 54, which will be described below, a rotation speed of the rotating electric machine 13, and a torque of the rotating electric machine 13. The various devices of the vehicle M include, for example, a driving control device 3, a power control device 10, and various auxiliary machines. Various auxiliary machines include, for example, power converters, air conditioners, various pumps, and the like. The first power limit compensation control unit 52b executes the first compensation control according to the states of various devices ascertained by the device state ascertaining unit 52a. The first power limit compensation control unit 52b generates a transmission power command related to power transmission in a contactless manner, and a driving torque command related to traveling driving force of the vehicle M so that a power balance at the input or output end of the power storage device 11 is zero. The first power limit compensation control unit 52b inputs a transmission power command, and a motor torque command related to the driving force of the rotating electric machine 13 among the driving torque commands to the motor ECU 54. The first power limit compensation control unit 52b inputs an engine torque command related to the driving force of the internal combustion engine among the driving torque commands to the engine ECU 53.

The engine ECU 53 controls an operation of the internal combustion engine according to an engine torque command input from, for example, the integrated ECU 52. The motor ECU 54 includes, for example, a power transmission processing unit 57 and a motor processing unit 58. The power transmission processing unit 57 includes, for example, a power transmission state ascertaining unit 57a, a second power limit compensation control unit 57b, a voltage control unit 57c, and a power transmission control unit 57d. The power transmission state ascertaining unit 57a acquires an output of power transmission between the power transmission device 2 and the power receiving device 14 based on a signal of a detection value output from the various sensors 56. The second power limit compensation control unit 57b executes second compensation control, which will be described below, depending on a power transmission state ascertained by the power transmission state ascertaining unit 57a. The voltage control unit 57c controls a voltage of the power storage device 11 by a voltage controller of the first power conversion device 12 in accordance with the second compensation control by the second power limit compensation control unit 57b. The power transmission control unit 57d controls a current of the power transmission by the power conversion unit 32 of the power receiving device 14 in accordance with the first compensation control by the first power limit compensation control unit 52b and the second compensation control by the second power limit compensation control unit 57b.

The motor processing unit 58 includes, for example, a motor state ascertaining unit 58a, a second power limit compensation control unit 58b, and a motor control unit 58c. The motor state ascertaining unit 58a acquires the rotation speed, torque, and the like of the rotating electric machine 13 based on the signal of a detection value output from the various sensors 56. The second power limit compensation control unit 58b executes second compensation control, which will be described below, according to a state of the rotating electric machine 13 ascertained by the motor state ascertaining unit 58a. The motor control unit 58c controls a current of the rotating electric machine 13 by a power converter of the first power conversion device 12 in accordance with the first compensation control by the first power limit compensation control unit 52b and the second compensation control by the second power limit compensation control unit 58b.

The second power limit compensation control unit 57b of the power transmission processing unit 57 and the second power limit compensation control unit 58b of the motor processing unit 58 execute the second compensation control while mutually transmitting and receiving various types of information. The two second power limit compensation control units 57b and 58b generate a command to be input to each of the voltage control unit 57c, the power transmission control unit 57d, and the motor control unit 58c to match the power received by the power receiving device 14 from the power transmission device 2 with the power required for the traveling driving force of the vehicle M. The second compensation control by each of the second power limit compensation control units 57b and 58b is executed within the motor ECU 54, thereby having a response relatively faster than, for example, the first compensation control by the first power limit compensation control unit 52b of the integrated ECU 52, which requires processing in another ECU.

The various sensors 55 include, for example, a current sensor, a voltage sensor, a temperature sensor, and the like for ascertaining a state of the power storage device 11 and power consumption of various auxiliary machines. The various sensors 56 include, for example, a current sensor, a voltage sensor, a temperature sensor, a rotation speed sensor, a torque sensor, and the like for ascertaining an output of the power transmission and a state of the rotating electric machine 13.

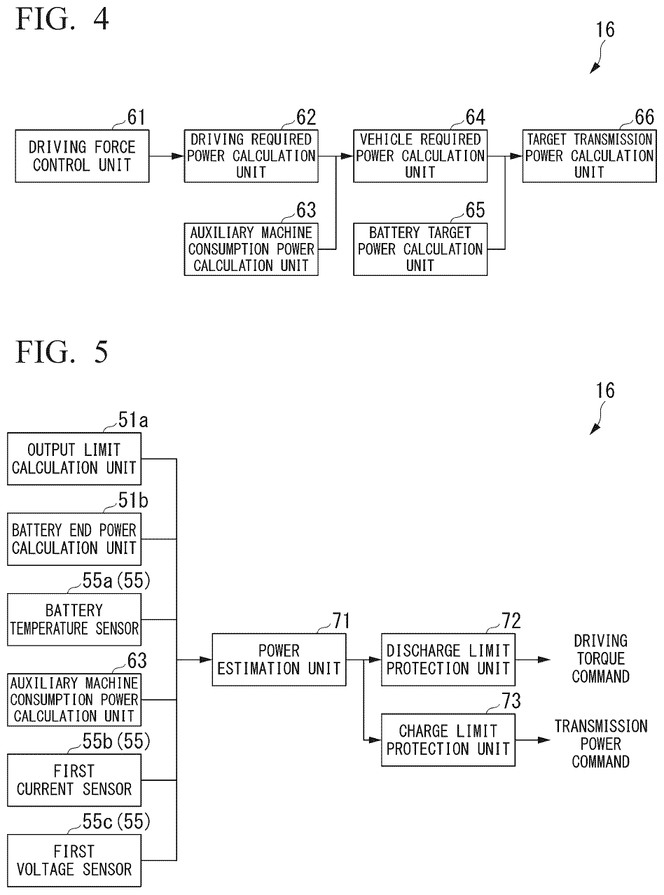

FIG. 4 is a block diagram which shows a functional configuration related to power supply control of the control device 16 in the contactless power transmission system 1. As shown in FIG. 4, the control device 16 includes, for example, a driving force control unit 61, a driving required power calculation unit 62, an auxiliary machine consumption power calculation unit 63, a vehicle required power calculation unit 64, a battery target power calculation unit 65, and a target transmission power calculation unit 66. The driving force control unit 61 calculates a target driving force of the vehicle M based on signals of detected values output from various sensors regarding a traveling state of the vehicle M. The various sensors include, for example, a speed sensor that detects a speed of the vehicle M, an accelerator position sensor that detects an amount of accelerator operation, and the like. Based on the target driving force input from the driving force control unit 61, the driving required power calculation unit 62 calculates required power (driving required power) according to the target driving force. The auxiliary machine consumption power calculation unit 63 calculates power consumption of various auxiliary machines (auxiliary machine power consumption) based on the signals of the detection values output from the various sensors 55. The vehicle required power calculation unit 64 calculates the required power for the vehicle M (vehicle required power) by adding the driving required power input from the driving required power calculation unit 62 and auxiliary machine power consumption input from the auxiliary machine consumption power calculation unit 63. The battery target power calculation unit 65 calculates a target power required for the power storage device 11 based on the signals of the detection values outputted from various sensors 55 and the like. The target transmission power calculation unit 66 subtracts the target power input from the battery target power calculation unit 65 from the vehicle required power input from the vehicle required power calculation unit 64, so that the power receiving device 14 can calculate a target of power (target transmission power) to be received from the power transmission device 2.

FIG. 5 is a block diagram which shows a functional configuration related to power storage device protection of the control device 16 in the contactless power transmission system 1. As shown in FIG. 5, the control device 16 includes, for example, a power estimation unit 71, a discharge limit protection unit 72, and a charge limit protection unit 73. The power estimation unit 71 calculates estimated power at input and output ends of the power storage device 11 (estimated battery end power) based on signals input from each of the output limit calculation unit 51a, the battery end power calculation unit 51b, the battery temperature sensor 55a, the auxiliary machine consumption power calculation unit 63, the first current sensor 55b, and the first voltage sensor 55c. Note that the battery temperature sensor 55a outputs a detected value of a temperature of the power storage device 11, the first current sensor 55b outputs a detected value of a current (a first current I1) of the power storage device 11, and the first voltage sensor 55c outputs a detected value of a voltage of the power storage device 11 (a first voltage V1). The discharge limit protection unit 72 generates a driving torque command to be input to the motor control unit 58c based on the estimated battery end power input from the power estimation unit 71 through, for example, feedback processing regarding power, and the like. The charge limit protection unit 73 generates a transmission power command to be input to the power transmission control unit 57d based on the estimated battery end power input from the power estimation unit 71 through, for example, feedback processing and feedforward processing regarding power.

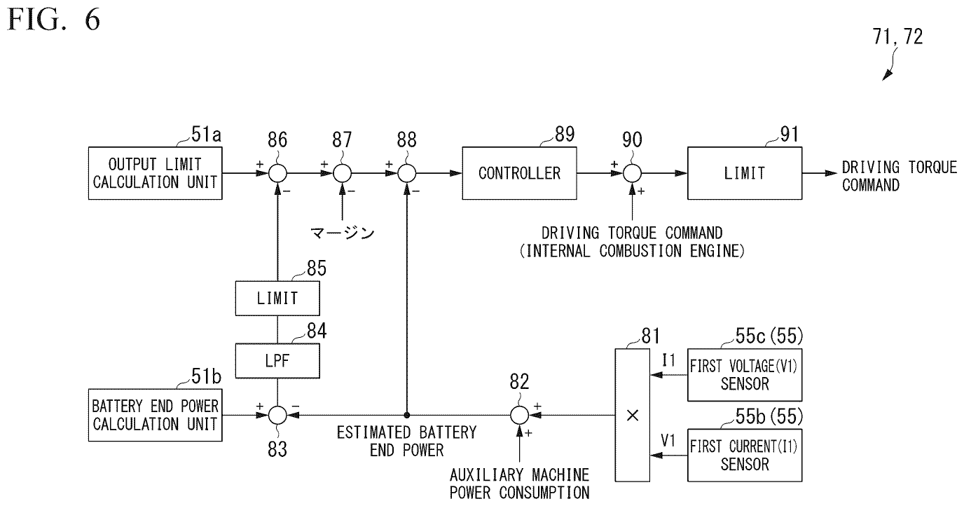

FIG. 6 is a block diagram which shows a functional configuration of the power estimation unit 71 and the discharge limit protection unit 72 of the control device 16 in the contactless power transmission system 1. As shown in FIG. 6, the power estimation unit 71 includes, for example, a power calculation unit 81 and a first addition unit 82. The power calculation unit 81 calculates power based on a voltage (the first voltage V1) and a current (the first current I1) of the power storage device 11. The first addition unit 82 calculates estimated battery end power by adding power output from the power calculation unit 81 and auxiliary machine power consumption output from the auxiliary machine consumption power calculation unit 63. The discharge limit protection unit 72 includes, for example, a first subtraction unit 83, a low-pass filter 84, a first limit processing unit 85, a second subtraction unit 86, a third subtraction unit 87, a fourth subtraction unit 88, and a controller 89, a second addition unit 90, and a second limit processing unit 91. The first subtraction unit 83 calculates differential power by subtracting the estimated battery end power from the battery end power output from the battery end power calculating unit 51b. The differential power output from the first subtraction unit 83 is subjected to high frequency component removal by the low-pass filter 84 and predetermined limitation by the first limit processing unit 85. A target power limit value output from the output limit calculation unit 51a is subjected to subtraction of differential power output from the first limit processing unit 85 using the second subtraction unit 86, subtraction of a predetermined margin using the third subtraction unit 87, and subtraction of the estimated battery end power using the fourth subtraction unit 88, and then is input to the controller 89.

The controller 89 executes, for example, predetermined feedback processing, and the like. The second addition unit 90 calculates a driving torque command by adding a control calculation value output from the controller 89 and a driving torque command regarding driving force of an internal combustion engine. The second limit processing unit 91 applies a predetermined limit to the driving torque command output from the second addition unit 90.

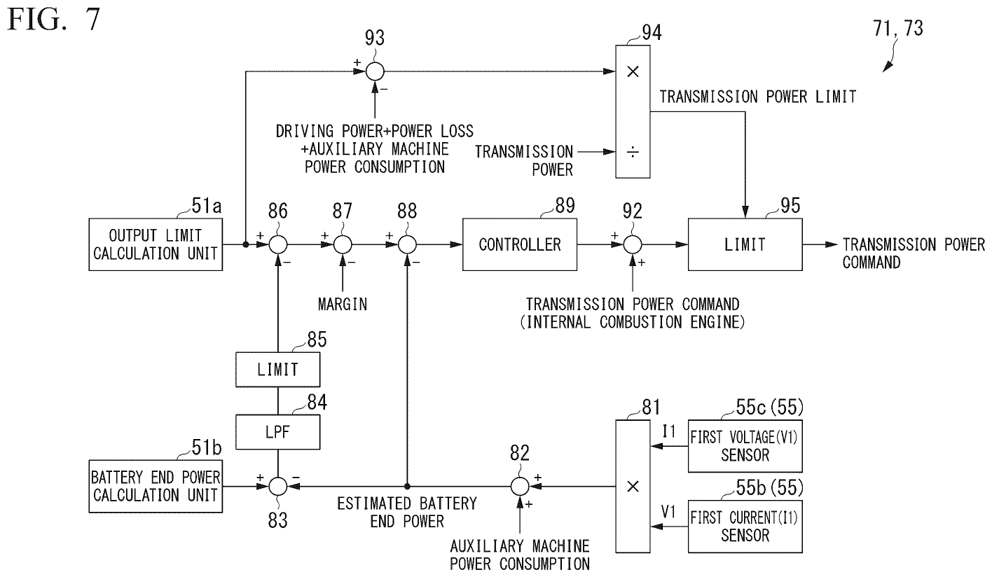

FIG. 7 is a block diagram which shows a functional configuration of the power estimation unit 71 and the charge limit protection unit 73 of the control device 16 in the contactless power transmission system 1. As shown in FIG. 7, the charge limit protection unit 73 includes, for example, the first subtraction unit 83, the low-pass filter 84, the first limit processing unit 85, the second subtraction unit 86, the third subtraction unit 87, the fourth subtraction unit 88, the controller 89, a third addition unit 92, a fifth subtraction unit 93, a transmission power limit calculation unit 94, and a third limit processing unit 95. The third addition unit 92 calculates a transmission power command by adding a control calculation value output from the controller 89 and a transmission power command regarding the driving force of the internal combustion engine. The fifth subtraction unit 93 subtracts driving power, power loss, and auxiliary machine power consumption from the target power limit value output from the output limit calculation unit 51a. Note that driving power is power related to the traveling driving force of the vehicle M, and power loss is a power loss related to power conversion in the driving control device 3. The transmission power limit calculation unit 94 calculates a transmission power limit in predetermined feedforward processing based on a calculated value and transmission power output from the fifth subtraction unit 93. Based on a transmission power command output from the second addition unit 90 and a transmission power limit output from the transmission power limit calculation unit 94, the third limit processing unit 95 performs, for example, processing such as selection of the smaller of the two and outputs a transmission power command.

By using the contactless power transmission system 1 described above, since charging can be performed when the vehicle M is moving while suppressing an occurrence of problems such as heat generation and shortened life of the power storage device 11 by using the power transmission from the power transmission device 2 as a virtual SOC, in addition to a remaining capacity (SOC: state of charge) of the power storage device 11 of the vehicle M, a capacity of the power storage device 11 does not need to be increased. In addition, time required to charge the power storage device 11 does not increase.

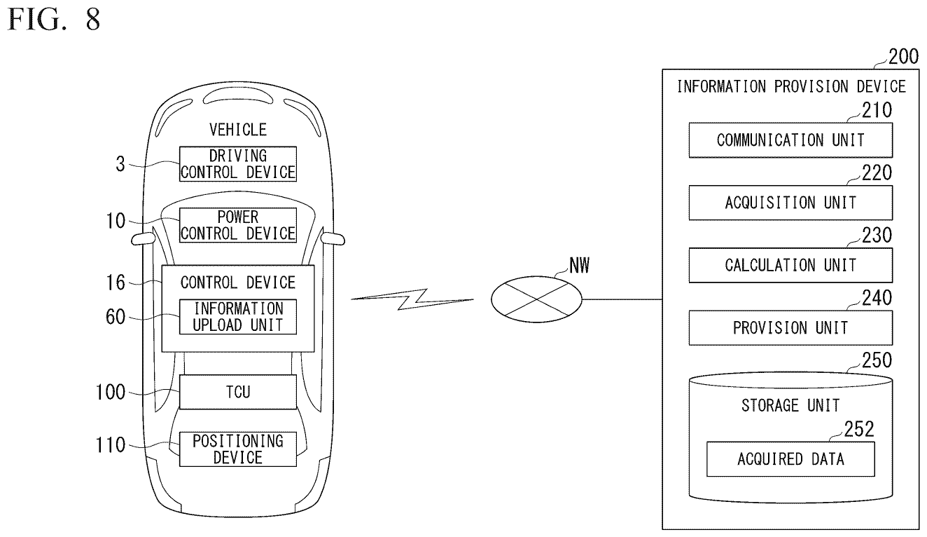

FIG. 8 is a diagram which shows an example of a configuration of the vehicle M and the information provision device 200. The vehicle M and the information provision device 200 communicate with each other via a network NW. The vehicle M is equipped with a driving control device 3, a power control device 10, a control device 16, a telematics control unit (TCU) 100, and a positioning device 110 in addition to a general configuration of a vehicle. The vehicle M is, for example, an electric vehicle that travels exclusively on electric power from the power storage device 11.

The control device 16 further includes an information upload unit 60. The information upload unit 60 transmits (uploads) data such as power consumption of the vehicle M to the information provision device 200 via a TCU 100. The TCU 100 is a wireless communication device. The control device 16 transmits results of measurement measured by a current sensor, a voltage sensor, a temperature sensor, and the like attached to the power storage device 11 to the information provision device 200 via the TCU 100. The control device 16 may transmit a charging upper limit voltage recognized by the power storage device 11, difference data of a discharge voltage measured for a certain period of time, and the like to the information provision device 200 via the TCU 100.

The positioning device 110 is, for example, a global navigation satellite system (GNSS) receiver, and specifies a position of the vehicle M on the basis of a signal received from a GNSS satellite, and outputs it as positional information.

The information provision device 200 includes, for example, a communication unit 210, an acquisition unit 220, a calculation unit 230, a provision unit 240, and a storage unit 250. Components other than the communication unit 210 and the storage unit 250 are realized by, for example, a hardware processor such as a central processing unit (CPU) executing a program (software). Some or all of these components may be realized by hardware (circuit unit; including circuitry) such as large scale integration (LSI), an application specific integrated circuit (ASIC), a field-programmable gate array (FPGA), and a graphics processing unit (GPU), or may also be realized by software and hardware in cooperation. A program may be stored in advance in a storage device (a storage device equipped with a non-transitory storage medium) such as a hard disk drive (HDD) or flash memory, may be stored in a removable storage medium (non-transitory storage medium) such as a DVD or CD-ROM, and may be installed by attaching the storage medium to a drive device.

The storage unit 250 may be realized by the various storage devices described above, an electrically erasable programmable read only memory (EEPROM), a read only memory (ROM), a random access memory (RAM), or the like. The storage unit 250 stores acquired data 252.

The communication unit 210 is a communication interface for connecting to the network NW. The communication unit 102 is, for example, a network card.

The acquisition unit 220 acquires a set of data and positional information indicating a position where the data has been measured from the control device 16 via the TCU 100, a network NW, and a communication unit 210. The acquisition unit 220 stores the acquired data and the like in the storage unit 250 as acquired data 252, which will be described below. As described above, the acquired data includes data regarding power consumption. The acquisition unit 220 may also acquire power receiving information of the power storage device 11 as well as the data regarding power consumption.

The calculation unit 230 processes acquired data 252. The calculation unit 230 performs, for example, filter processing to average the acquired data 252 of the vehicle M over an observation period of about 3 seconds. In the following description, it is assumed that the acquired data 252 is exclusively power consumption. The calculation unit 230 calculates, for example, a total value of power consumption (area power consumption) in a section (area) of 1 [km]×1 [km] on the basis of the set of power consumption and positional information, and performs meshing processing to be able to display power being consumed at that moment.

The provision unit 240 visualizes a result of the meshing processing by the calculation unit 230 and transmits it to an external device via the network NW. The external device is, for example, a device (a terminal device or a server device) whose display screen is viewed by a monitor of a power company. Visualization means, for example, processing the result of the meshing processing into a map format or processing it into a table format to provide it to an external device.

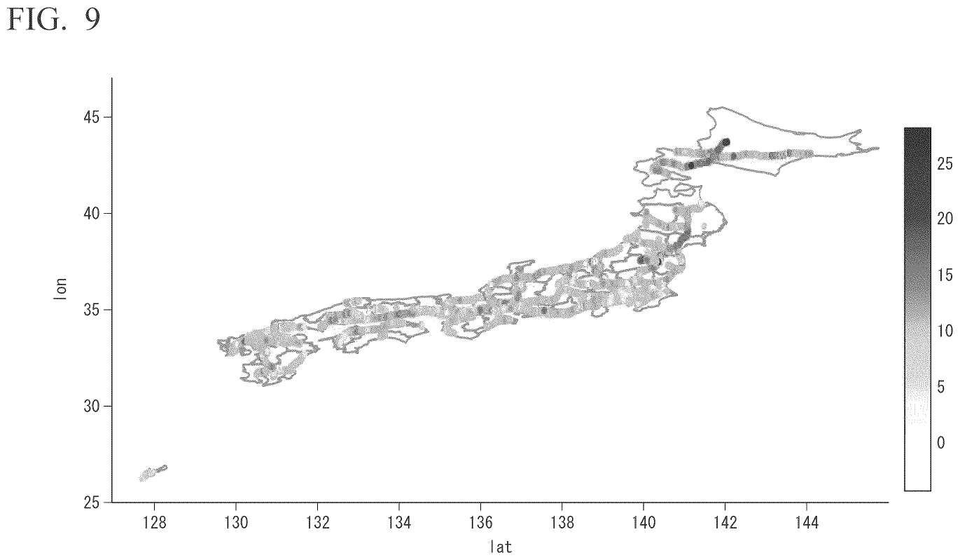

FIG. 9 is an example of a result of the meshing processing performed by the calculation unit 230. Shading represents an amount of power consumed. Power consumption increases as the shading grows darker, and power consumption decreases as the shading grows lighter.

Note that the acquired data 252 may be data related to power consumption or data related to an SOC of the power storage device 11. The calculation unit 230 may process the power receiving information of the power storage device 11 acquired by the acquisition unit 220 and add information on how much power the vehicle M has received and charged the power storage device 11. The provision unit 240 may add further information to the processed acquired data 252 using the power receiving information added by the calculation unit 230. A total sum of power originally charged in the power storage device 11 of the vehicle M, power consumption of an in-vehicle device mounted in the vehicle M, and power received while the vehicle M is traveling may be calculated. It may be possible to refer to a breakdown of these types of information.

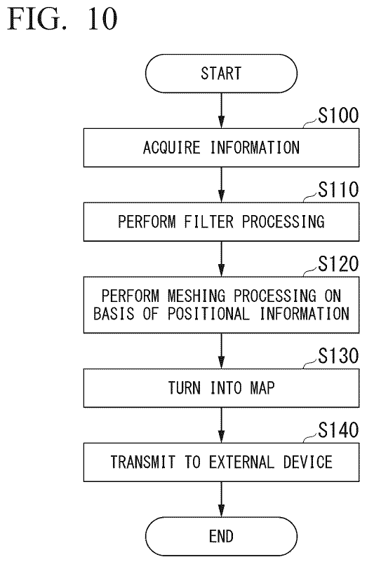

FIG. 10 is a flowchart which shows an example of an operation of the first embodiment. First, the acquisition unit 220 acquires information from the vehicle M (step S100). Here, the acquisition unit 220 acquires the power consumption of the vehicle M.

The calculation unit 230 performs filter processing on the acquired data 252 (step S110).

The calculation unit 230 performs meshing processing on the acquired data 252 that has been subjected to filter processing in step S110 on the basis of the positional information (step S120). Here, the data is processed to be mesh data of 1 [km]×1 [km].

The provision unit 240 maps the meshed acquired data 252 (step S130).

The provision unit 240 transmits the mapped acquired data 252 to an external device (step S140).

According to the first embodiment described above, the information provision device 200 acquires the power consumption of the vehicle M while it is traveling, visualizes it, and transmits the data to an external device, thereby clearly communicating the power supply required for each area.

### Second Embodiment

A second embodiment will be described below. The second embodiment has the same configuration as the first embodiment, so redundant description will be omitted. In the second embodiment, a size of a mesh data section can be changed for each district during meshing processing.

In an urban area, the power transmission device 2 is installed, for example, in front of a traffic light or an intersection, and is assumed to supply power when the vehicle M is stopped, such as waiting at a traffic light. On the other hand, the power transmission devices 2 are installed at intervals of, for example, 50 [m] in locations other than the urban area, and it is assumed that the vehicle M receives power while it is traveling.

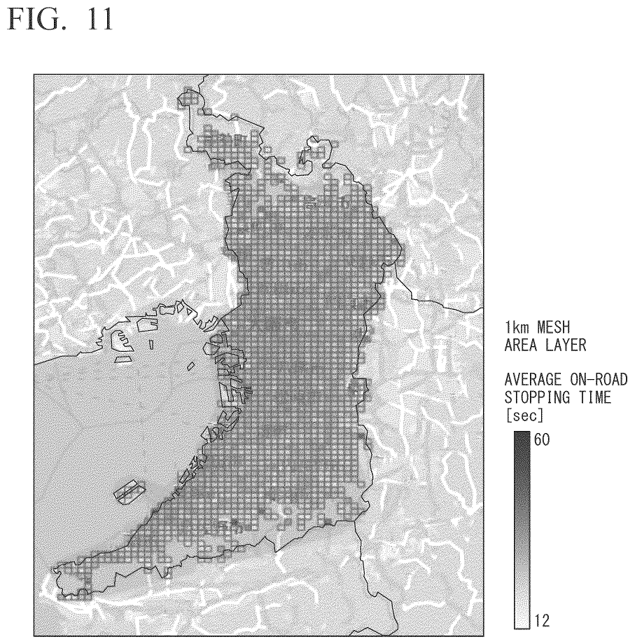

When the contactless power transmission system 1 is used, for example, if the vehicle M stops for a predetermined period of a time T1 (for example, more than ten [sec]), the power storage device 11 of the vehicle M is sufficiently charged. Therefore, it is preferable that a size of the meshing processing section in the urban area be set such that a cumulative stopping time while passing through the section is about the predetermined time T1. FIG. 11 is a diagram which shows an example of average on-road stopping time in a certain area. In FIG. 11, the mesh data is 1 [km]×1 [km], the shading grows darker as the average on-road stopping time is extended, and the shading grows lighter as the average on-road stopping time is shortened. In urban areas, there are many places with traffic lights and intersections, so that the average stopping time tends to be longer, while suburban areas tend to have a shorter average stopping time because there are fewer places with traffic lights and intersections.

The calculation unit 230 can change the size of the mesh data section on the basis of the positional information when meshing processing is performed on the acquired data 252. For example, the calculation unit 230 changes the size to 10 [km]×10 [km] in an urban area and changes the size to 1 [km]×1 [km] in areas other than the urban area.

By providing area data to the calculation unit 230 in advance, the calculation unit 230 can be made to determine which area corresponds to the urban area.

If a division of mesh data is made small in an urban area, this is not preferable because it is assumed that no power transmission devices 2 will be present in the division, or that the power transmission devices 2 will be unevenly distributed. On the other hand, if it is a place where the power transmission devices 2 are installed at intervals of 50 [m], detailed data can be obtained by setting a section as small as possible in an assumption that the section is larger than 50 [m]. For this reason, the calculation unit 230 makes a section in an urban area larger than a section in other districts. This makes it possible to accurately ascertain power demand and, in turn, provide data for determining how to prioritize a supply of power to places where it is needed.

According to the second embodiment described above, as in the first embodiment, the required power supply for each area can be clearly communicated. In addition, by switching the size of a mesh data section between urban area and other areas, it is possible to provide more appropriate power supply information.

The embodiment described above can be expressed as follows.

A device includes a storage medium configured to store computer-readable instructions, and one or more processors that are connected to the storage medium, wherein the one or more processors execute the computer-readable instructions to acquire power receiving information and positional information on the power reception through communication from a communication device installed in a vehicle equipped with a power receiving device that receives power from a power supply device installed on a road in a contactless manner, calculate an area power consumption by aggregating the power receiving information for each area on the basis of the positional information, and visualize the area power consumption to provide it to other devices.

Although a mode for implementing the present invention has been described above using embodiments, the present invention is not limited to these embodiments in any way, and various modifications and substitutions can be added within a range not departing from the gist of the present invention.

What is claimed is:

1. An information provision device comprising:
a storage medium configured to store computer-readable instructions; and
one or more processors that are connected to the storage medium,
wherein the one or more processors execute the computer-readable instructions to:
acquire power receiving information and positional information on the power reception through communication from a communication device installed in a vehicle equipped with a power receiving device that receives power from a power supply device installed on a road in a contactless manner,
calculate an area power consumption by aggregating the power receiving information for each area on the basis of the positional information, and
visualize the area power consumption to provide it to other devices.

2. The information provision device according to claim 1,
wherein the one or more processors executes the computer-readable instructions to switch a size of the area between an urban area and other areas.

3. The information provision device according to claim 2,
wherein the one or more processors execute the computer-readable instructions to make a size of an area of the urban area larger than a size of an area of other areas.

4. The information provision device according to claim 1,
wherein the one or more processors execute the computer-readable instructions to:
acquire, in addition to power receiving information on the power reception, information on power consumption of an in-vehicle device installed in the vehicle; and
visualize the power consumption of the in-vehicle device to provide it to other devices.

5. An information provision method that is executed by an information provision device, comprising:
acquiring power receiving information and positional information on the power reception through communication from a communication device installed in a vehicle equipped with a power receiving device that receives power from a power supply device installed on a road in a contactless manner;
calculating an area power consumption by aggregating the power receiving information for each area on the basis of the positional information, and
visualizing the area power consumption to provide it to other devices.

6. A non-transitory computer readable storage medium that stores a program for causing a processor of an information provision device to:
acquire power receiving information and positional information on the power reception through communication from a communication device installed in a vehicle M equipped with a power receiving device that receives power from a power supply device installed on a road in a contactless manner;
calculate an area power consumption by aggregating the power receiving information for each area on the basis of the positional information; and
visualize the area power consumption to provide it to other devices.
